(19) United States
(12) Patent Application Publication
(10) Pub. No.: US 2010/0245560 A1
(43) Pub. Date: Sep. 30, 2010

(54) METHOD AND DEVICE FOR IMAGING A FRAGMENTATION PATTERN FORMED IN A PLY OF TOUGHENED GLASS

(75) Inventor: Simon Peter Aldred, Lancashire (GB)

Correspondence Address: BUCHANAN, INGERSOLL & ROONEY PC, POST OFFICE BOX 1404, ALEXANDRIA, VA, 22313-1404, US

(73) Assignee: Pilkington Group Limited, St. Helens (GB)

(21) Appl. No.: 12/740,018

(22) PCT Filed: Oct. 29, 2008
(86) PCT No.: PCT/GB2008/051014

§ 371 Date: Apr. 27, 2010

(30) Foreign Application Priority Data
Apr. 27, 2010 (GB) 0721060.2

(51) Int. Cl. H04N 7/18

(52) U.S. Cl. 348/92; 348/E07.085

(57) ABSTRACT

A method of imaging a fragmentation pattern formed in a single ply of toughened glass having first and second opposing surfaces is disclosed. Initially, a region of the fragmentation pattern is aligned with an image capture device, where the image capture device is arranged in a spaced relationship with the first surface of the ply of glass to capture images of the region when being illuminated in transmission. The region is then illuminated from a first illumination direction and capturing a first image of the region, and subsequently illuminated from at least a second illumination direction and capturing at least a second image of the region. The images are then superimposed to produce a composite image of the region. Preferably four images are obtained. A vehicle glazing optical inspection apparatus for carrying out such a method is also disclosed.

The present invention relates to a method of, and an apparatus for, inspecting glazings, in particular, a method of imaging fragmentation patterns produced in a single ply of toughened glass.

Optical inspection methods may be used to determine whether a glazing meets various safety standards. Typically, optical inspection methods are used to determine whether a glazing meets optical standards, for example, the secondary image test under ECE R43. However, optical inspection methods may also be used to help determine whether a glazing meets impact resistance standards.

Under ECE R43, toughened glass for automotive use is toughened to the extent that it passes the fragmentation test for uniformly toughened glass panes specified in ECE R43 (the relevant safety standard in Europe for automotive glazings) in which the number of fragments in any 5 cm×5 cm square is not less than 40 or more than 400, or in the case of a glazing not more than 3.5 mm thick, 450. In order to measure the number of fragments, having boundaries and separated by fracture lines, the area of the largest fragment and the length of the longest fragment in the test region, a single ply of glass is placed on a sheet of photosensitive paper before the impact test is carried out. Once the glass has been fractured, the photosensitive paper is exposed to light, creating a contact print of the fracture pattern. The number, shape and size of fragments in selected region are then ascertained. This may be done by eye, with an operator counting and measuring the fragments, or using an automated system, such as that disclosed by Ford Motor Co. in Glass Processing Days, 13-15 Sep. 1997. In this method, it is necessary to both filter and threshold the image prior to counting. The use of either method however, is time consuming.

An alternative method of imaging and processing the test data is disclosed in U.S. Pat. No. 6,766,046. A light source is positioned above a ply of glass supported on a paper screen held on a transparent guide sheet. A camera, having a line sensor, is positioned underneath the screen to detect the image of the fragments projected onto the screen by the light source. Either the glass or the camera may be moved to ensure that the entire area of the ply of glass is scanned. The light source may be a point source, combined with a condensing lens, or an array of light sources.

The automation of the data collection and image processing reduces the amount of time necessary to determine whether a ply of glass has passed or failed the fragmentation test. However, the use of the screen (where the camera records the screen image rather than a direct image from the glass) causes difficulties when glass having a low light transmission is tested. In U.S. Pat. No. 6,766,046, low light transmission is overcome by employing a photosensor to determine the light transmission of the glass so that the exposure time needed by the camera to record the image on the screen may be adjusted accordingly. However, for low light transmission glass, this increases the amount of time required for data acquisition. In order for an automated system to be viable in a production situation, the image capture ideally needs to be completed within a three minute time window.

One difficulty with imaging fragmentation patterns is that the direction of the fracture boundaries varies across the fracture pattern. This means that when viewing the fracture pattern from a fixed point there are always some fracture boundaries that appear very thin, whilst others are more clearly visible because they are viewed side on. Whilst these boundaries are just visible to the human eye, the small widths involved lead to difficulties in ensuring that all of the fragment boundaries are imaged with a digital camera. For example, some boundaries may not be clearly visible, and therefore eliminated in filtering and thresholding of the image of the fragmentation pattern, and some cracks within fragments, or even the edges of the tape used to hold the sample together may be mistaken for fragment boundaries and included erroneously.

It is therefore desirable to be able to provide a clear, high-quality image of a fragmentation pattern, which is easily and quickly obtained, using a method that minimises the omission and/or erroneous inclusion of fragment boundaries when using an automated fragment counting system.

The present invention aims to address the problems of the prior art by providing a method of imaging a fragmentation pattern formed in a single ply of toughened glass having first and second opposing surfaces; comprising aligning a region of the fragmentation pattern with an image capture device, the image capture device being arranged in a spaced relationship with the first surface of the ply of glass to capture images of the region when being illuminated in transmission; illuminating the region from a first illumination direction and capturing a first image of the region; illuminating the region from at least a second illumination direction and capturing at least a second image of the region; and superimposing the images to produce a composite image of the region.

By illuminating a region of the fragmentation pattern with light from at least two and preferably three or four directions, it is possible to ensure that all fragment boundaries are imaged, and the number of omitted or erroneous fracture lines in the final image reduced compared with prior art methods.

Preferably, light from the first and at least second illumination directions is provided by separate point light sources.

Preferably, the light sources are light emitting diodes.

The light may be provided by a single light source.

The image capture device may capture an image of the fragmentation pattern formed on a screen.

Preferably, the method further comprises the steps of illuminating the region from a third illumination direction and capturing a third image of the region; illuminating the region from a fourth illumination direction and capturing at least a fourth image of the region; before superimposing the images to produce a composite image of the region.

Preferably, the images captured are bright-field images. Alternatively, images captured may be dark-field images.

The present invention also provides a vehicle glazing optical inspection apparatus, for imaging a fragmentation pattern formed, in accordance with ECE R43, in a single ply of toughened glass having first and second opposing surfaces; comprising a support surface; an illumination system, positioned so as to illuminate a ply of toughened glass placed on the support surface in transmission; and an imaging arrangement; wherein the illumination system comprises at least two point light sources inclined at an angle of α to the vertical, and positioned to illuminate the ply of toughened glass in complementary illumination directions.

Preferably, the illumination system comprises four point light sources.

Preferably, the point light sources are light emitting diode arrangements. The light emitting diode arrangements may comprise an LED and lens arrangement housed within a casing.

Preferably, the imaging arrangement comprises a housing in which an image capture device, focussing means and a translucent scattering surface are mounted. The image capture device is preferably an area scan CCD (charge coupled device) camera.

The angle α is preferably in the range of 5° to 15°.

The present invention will now be described by way of example only, and with reference to the accompanying drawings in which:

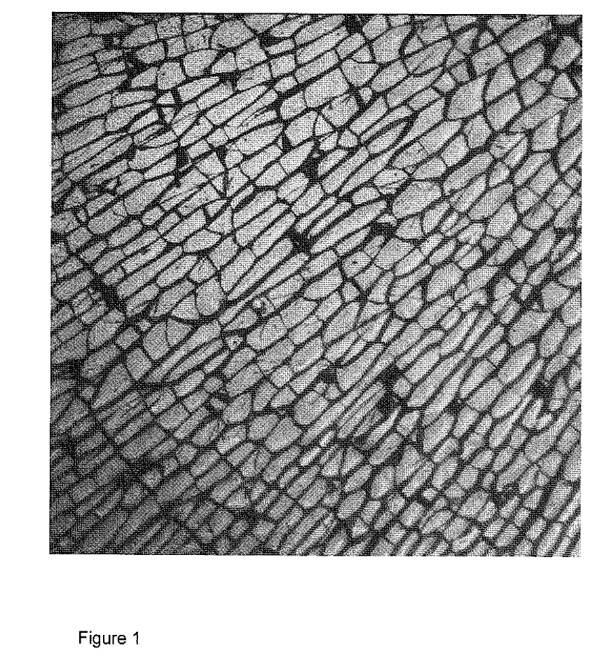

FIG. 1 is an image of a fragmentation pattern;

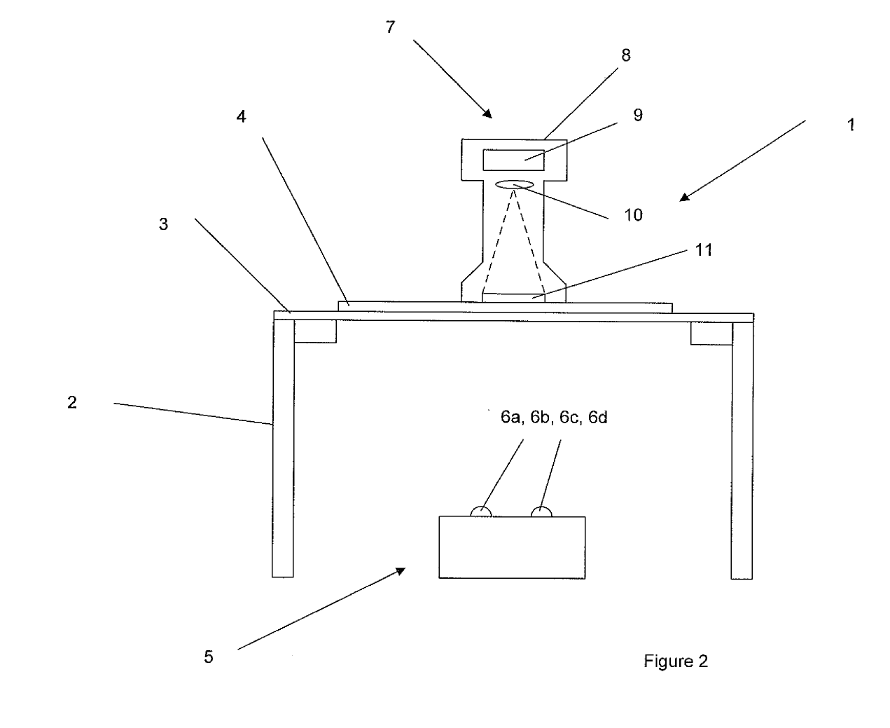

FIG. 2 is a schematic cut-away view of apparatus for carrying out the method of the present invention;

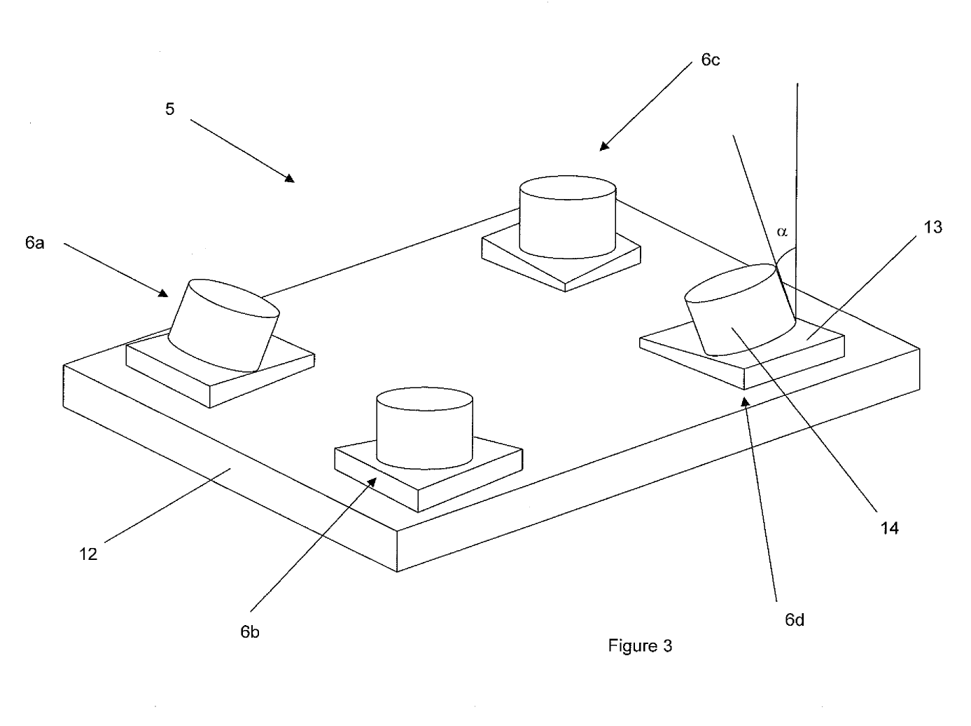

FIG. 3 is a schematic plan view of an illumination system for use with the method of the present invention;

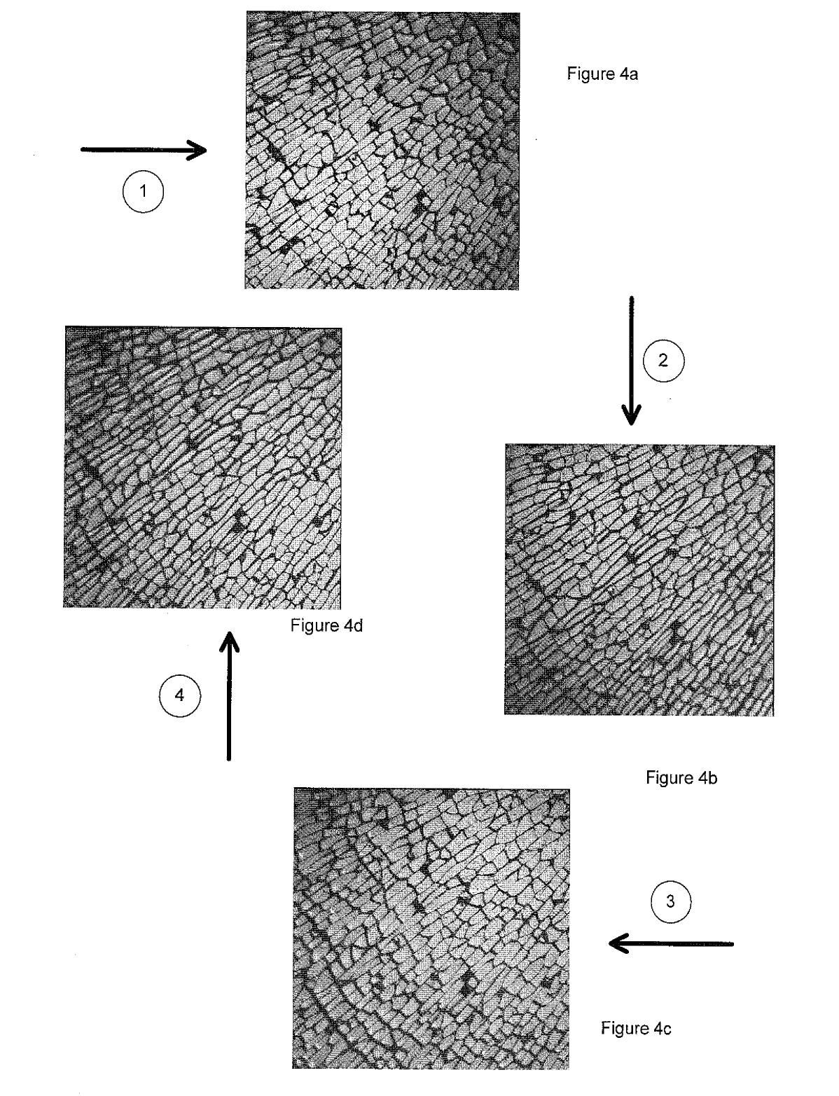

FIGS. 4a, 4b, 4c and 4d are schematic representations of the illumination of a fragmentation pattern carried out as part of the method of the present invention; and

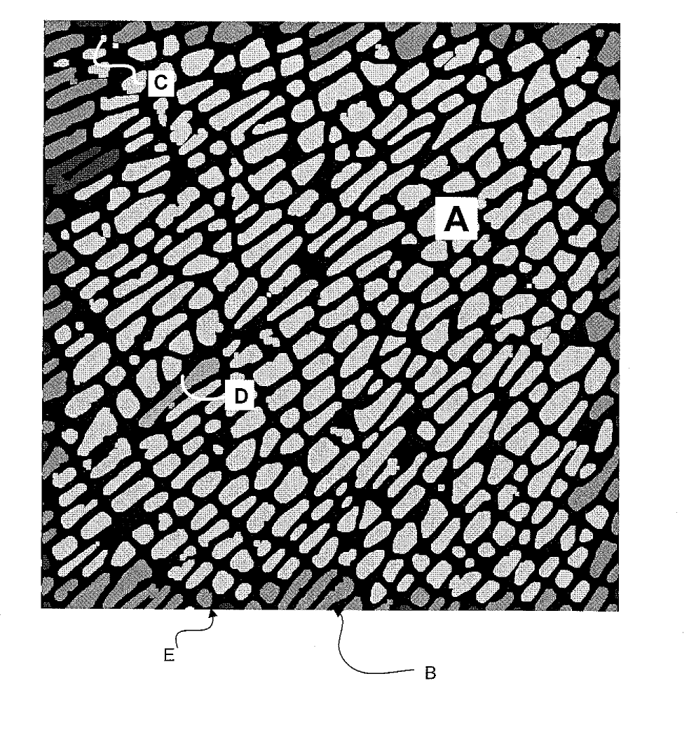

FIG. 5 is a computer-generated composite image based on the illuminations shown in FIGS. 4a, 4b, 4c and 4d.

In order to minimise the likelihood of an automated counting system for a fragmentation pattern omitting fragment boundaries or including erroneous boundaries, such as tape, the present invention describes a method for capturing a series of high quality images of the same region of a fragmentation pattern illuminated by light having a non-normal angle of incidence, from various illumination directions. Preferably the illumination directions are complementary, such that when viewed perpendicular to the upper surface of the ply of glass they are spaced at equal angles about the mid-point of the region being imaged. This enables all fragment boundaries to be imaged clearly, with sufficient but not excessive broadening of the fracture lines. Using the resulting image with an automated counting system that counts and sizes the number of fragments within the pattern, gives a rapid determination of whether the glass meets the fragmentation test under ECE R43.

In the description and examples below, the fragmentation patterns are illuminated using bright-field techniques. Consequently, the images captured are bright-field images. However, as an alternative, the fragmentation patterns may be illuminated using dark-field techniques, with the resulting captured images being dark-field images.

FIG. 1 shows a fragmentation pattern in a single ply of toughened glass. The image was acquired using the apparatus described below. In order to create the pattern, a curved, toughened ply of glass was first taped (to ensure that all the fragments are held together after impact) and then an impact made. In accordance with ECE R43, a spring loaded centre punch was used to create the impact in the centre of the glass. This caused the glass to fragment and the curvature in the ply to relax. The test was carried out on a ply of glass taken from a production line. In order to create a sharp and accurate image of the fragments, enabling automated counting software to be used to count and size the fragments, the fragmentation pattern within the ECE R43 50 mm×50 mm counting zone may be imaged in accordance with the invention, as described below.

FIG. 2 is a schematic cut-away view of apparatus for imaging a fragmentation pattern in accordance with the method of the present invention, which forms a vehicle glazing optical inspection apparatus. The apparatus 1 comprises a support table 2 having a support surface 3 formed from a ply of a transparent material, such as glass, for supporting the test glass. Table 2 supports the test glass 4 at a height h above an illumination system 5, so that the test glass 4 is imaged in transmission. The illumination system 5 comprises four light-emitting diode (LED) units 6a, 6b, 6c, 6d of which only two are illustrated in FIG. 2. The arrangement of the LED units 6a, 6b, 6c, 6d is shown in more detail in FIG. 3. Each LED unit 6a, 6b, 6c, 6d is effectively a point light source, emitting a beam of light travelling in an illumination direction.

The apparatus 1 also includes an imaging arrangement 7, comprising a housing 8 in which an image capture device 9, focussing means 10 and a translucent scattering surface 11 are mounted. In this example, the image capture device 9 is an area scan CCD (charge coupled device) camera with a resolution of 1280×1024 pixels. The focussing means 9 comprise a C mount lens having a focal length f of 16 mm. The scattering surface 11 is provided as a projection screen for the image of the fragmentation pattern, enabling the image capture device 9 to focus clearly onto the shadow of the fracture pattern from above. The scattering surface 11 is positioned at the base of the housing so that it is almost in contact with the glass surface and may be formed from ground glass or plastic, but not exclusively so. The distance of the lens from the scatter surface is such that a 50 mm×50 mm region of the fracture pattern may be imaged by the image capture device. The image capture device 9 is connected to a computer.

FIG. 3 is a schematic plan view of the illumination system 5. The illumination system 5 comprises four LED units 6a, 6b, 6c, 6d arranged on a support surface 12. The LED units 6a, 6b, 6c, 6d are effectively positioned at each corner of a square on the support surface 12. Each LED unit 6a, 6b, 6c, 6d comprises a base portion 13 and a lighting portion 14, where the lighting portion contains an LED and lens arrangement housed within a casing. Each base portion 13 is adjustable by means of a series of screws (not shown) so that the angle of the LED 14 and hence the beam of light may be adjusted relative to a normal extending vertically from the centre of the LED arrangement. Rather than pointing vertically upwards at an angle of 90° to the support surface and therefore illuminating the surface at a normal angle of incidence, the lighting portions 14 are inclined at an angle of α to the vertical, as shown in FIG. 3. Preferably, α is in the range 5° to 15° to the vertical, more preferably 7° to 11° to the vertical.

If the angle of incidence is too close to the vertical then fragment boundaries do not appear sufficiently broadened in the transmitted shadow pattern. If the angle of incidence is too far from the vertical, such as greater than 15° to the vertical, then shadows cast by the fragment boundaries are broadened to such an extent that small fragments, which ought to be included in the fragment count, are no longer visible. By using such an arrangement, the image of the fracture pattern can be optimised so that small particles of the order 2 mm×2 mm can still be imaged but there is still sufficient broadening of fragment boundaries to enable all fragment boundaries to be detected, regardless of orientation.

The angle used is chosen with regard to the thickness range of the glass to be analysed and the size of fragments to be distinguished. The thicker the glass, broader the shadow lines will be, and hence a smaller illumination angle is needed to reduce the risk of fracture lines merging. Conversely, in thin glass relatively thin shadow lines are generated so illumination from a larger illumination angle is possible whilst still avoiding the merger of fracture lines. For the range of glass typically used in automotive applications, (3 mm to 6 mm), an angle of 9° to the vertical is sufficient to measure all glass thicknesses with fracture count densities up to 400.

The light emitted by the LED units 6a, 6b, 6c, 6d is in complementary illumination directions, such that when viewed perpendicular to the upper surface of the ply of glass the illumination directions are spaced at 90° angles about the mid-point of the region being imaged.

Each LED unit is connected to an external power supply (not shown) and is switched on and off under the control system, such as a computer (also not shown). In addition, a diode laser 15 is positioned centrally between all four LED units 6a, 6b, 6c, 6d, to be incident on the underside of the single ply of toughened glass. The laser is used to ensure that the image capture device 9 is positioned accurately above the LED units 6a, 6b, 6c, 6d. This can be further enhanced by the use of a template (not shown) having an aperture corresponding to the external dimensions of the housing 8 of the imaging system 7, which may be positioned over an area of interest for imaging to help ensure the correct alignment.

The method of imaging the fracture pattern, in accordance with the present invention, will now be described.

Initially, the ply of test glass 4 to be imaged, having first and second opposing surfaces already undergone a fragmentation impact in accordance with the test under ECE R43 is placed onto the support surface 3. The region to be tested is positioned above the illumination system 5, and the imaging system 7 placed over this region. The imaging system 7 is then aligned with the illumination system (using the laser, the template or both). By use of the housing, the image capture device is placed in a spaced relationship with the first surface of the ply of test glass 4. In order to image the fragmentation pattern, the ply of glass 3 is illuminated sequentially by each of the LED units 6a, 6b, 6c, 6d. The control system synchronises the switching on and off of each of the LED units 6a, 6b, 6c, 6d with a single image capture of the image capture device 9. This is illustrated schematically in FIGS. 4a, 4b, 4c and 4d. Each LED emits monochromatic red light, but other colours could be used just as well.

Initially, a first LED unit 6a is switched on and illuminates the fragmentation pattern at a non-normal angle of incidence to the second surface of the ply of test glass 4 in a first illumination direction, indicated by direction arrow 1 in FIG. 4a. The image capture device 9 captures a first image of the fragmentation pattern, and the LED unit 6a is switched off. A second LED unit 6b is then switched on, and illuminates the fragmentation pattern at a non-normal angle of incidence to the second surface of the ply of test glass 4 in a second illumination direction, indicated by direction arrow 2 in FIG. 4b. The image capture device 9 captures a second image of the fragmentation pattern, and the LED unit 6b is switched off.

A third LED unit 6c is then switched on to illuminate the fragmentation pattern at a non-normal angle of incidence to the second surface of the ply of test glass 4 in a third illumination direction, indicated by direction arrow 3 in FIG. 4c. The image capture device 9 captures a third image of the fragmentation pattern, and the LED unit 6c is switched off. A fourth LED unit 6d is then switched on to illuminate the fragmentation pattern at a non-normal angle of incidence to the second surface of the ply of test glass 4 in a fourth illumination direction, indicated by direction arrow 4 in FIG. 4d. The image capture device 9 captures a fourth image of the fragmentation pattern, and the LED unit 6c is switched off.

Once the illumination of the fragmentation pattern is complete, the first, second third and fourth images are processed by the control system and overlaid to produce a single composite image of the fragmentation pattern. This composite image shows the boundaries between all the individual fragments clearly, as information showing the same boundary from four different directions is combined. Automated counting software may then be used to count and size the fragments in accordance with the ECE R43 test.

FIG. 5 is a computer-generated composite image based on the illuminations shown in FIGS. 4a, 4b, 4c and 4d. The image comprises two main regions: a central region, shown in light grey (area A), where all of the fragments can be imaged and counted, and a boundary region, coloured mid grey (area B), where whole fragments cannot be resolved. White areas in the central region (such as that marked “C”) indicate fragments that are too small to be counted (less than 1 mm×1 mm), and dark grey areas (such as that marked “D”) indicate the longest fragments. The boundary region also comprises fragments that cannot be counted (such as that marked “E”). As can be seen from the image, the resolution of the fracture boundaries is excellent.

In the above example, four co-planar point light sources are used, positioned to illuminate fragment boundaries from four different directions. However, other arrangements of point light sources may be used. For example, the point light sources need not be co-planar, monochromatic or same wavelength. For example, point light sources emitting green, blue or white light, may be used alone, instead of or in combination with light sources emitting red light, as in the above example.

The minimum number of point light sources necessary to obtain an improved composite image by emitting light in complementary illumination directions is two. Ideally, such point light sources should be positioned such that the illumination directions when viewed perpendicular to the upper surface of the ply of glass they are spaced at 180° about the mid-point of the region being imaged. Similarly, three point light sources could be used, positioned such that the illumination directions when viewed perpendicular to the upper surface of the ply of glass they are spaced at 120° angles about the mid-point of the region being imaged. Five or more point light sources could be arranged in a similar manner.

Alternatively, a single point light source may be used, the position of which may be altered to allow for various directions of illumination during image capture. This may be done with a turntable or other moveable device. Multiple image capture devices may be used with either a single or multiple point light sources. In each case, the images may still be superimposed to obtain a single, composite image. Improved images are possible as long as the relative positions of either the illuminated region and image capture device, illuminated region and light source or light source and image capture device are constant, to enable image processing.

Point light sources other than LEDs may be used in the illumination system, and alternative image capture devices, such as CMOS (complementary metal-oxide semiconductor) devices may be used.

1. A method of imaging a fragmentation pattern formed, in accordance with ECE R43, in a single ply of toughened glass having first and second opposing surfaces; comprising:
aligning a region of the fragmentation pattern with an image capture device, the image capture device being arranged in a spaced relationship with the first surface of the ply of glass to capture images of the region when being illuminated in transmission;
illuminating the region from a first illumination direction and capturing a first image of the region;
illuminating the region from at least a second illumination direction and capturing at least a second image of the region; and
superimposing the images to produce a composite image of the region.

2. The method of claim 1, wherein light from the first and at least second illumination directions is provided by separate point light sources.

3. The method of claim 2, wherein the light sources are light emitting diodes.

4. The method of claim 1, wherein the light is provided by a single light source.

5. The method of claim 1, wherein the image capture device captures an image of the fragmentation pattern formed on a screen.

6. The method of claim 1, further comprising the steps of:
illuminating the region from a third illumination direction and capturing a third image of the region;
illuminating the region from a fourth illumination direction and capturing at least a fourth image of the region;
before superimposing the images to produce a composite image of the region.

7. The method of claim 1, wherein the images captured are bright-field images.

8. The method of claim 1, wherein the images captured are dark-field images.

9. Vehicle glazing optical inspection apparatus, for imaging a fragmentation pattern formed, in accordance with ECE R43, in a single ply of toughened glass having first and second opposing surfaces; comprising:
a support surface;
an illumination system, positioned so as to illuminate a ply of toughened glass placed on the support surface in transmission; and
an imaging arrangement;
wherein the illumination system comprises at least two point light sources inclined at an angle of α to the vertical, and positioned to illuminate the ply of toughened glass in complementary illumination directions.

10. The apparatus of claim 9, wherein the illumination system comprises four point light sources.

11. The apparatus of claim 9, wherein the point light sources are light emitting diode arrangements.

12. The apparatus of claim 11, wherein the light emitting diode arrangements comprise an LED and lens arrangement housed within a casing.

13. The apparatus of claim 9, wherein the imaging arrangement comprises a housing in which an image capture device, focussing means and a translucent scattering surface are mounted.

14. The apparatus of claim 13, wherein the image capture device is an area scan CCD (charge coupled device) camera.

15. The apparatus of claim 9, wherein the angle α is in the range of 5° to 15°.
